(19) United States
(12) Patent Application Publication
(10) Pub. No.: US 2026/0180235 A1
(43) Pub. Date: Jun. 25, 2026

(54) CONNECTOR

(71) Applicant: SUMITOMO WIRING SYSTEMS, LTD., Mie (JP)

(72) Inventor: Shifumi SADAKATA, Mie (JP)

(21) Appl. No.: 18/854,981

(22) PCT Filed: Apr. 10, 2023
(86) PCT No.: PCT/JP2023/014563

§ 371 Date: Oct. 8, 2024

(30) Foreign Application Priority Data
Apr. 13, 2022 (JP) 2022-066076

(51) Int. Cl. H01R 13/516; H01R 13/42

(52) U.S. Cl. CPC H01R 13/516; H01R 13/42

(57) ABSTRACT

A connector includes a male housing and a female housing. The male housing has a tubular hood part to which the female housing is fitted. The female housing has an opposed surface that is opposed to a back surface of the hood part. The opposed surface has a first opposed surface in which an insertion port is open, and a second opposed surface that is arranged between the second opposed surface and the first opposed surface with a female stepped surface interposed therebetween. The back surface has a first back surface that is opposed to the first opposed surface, a second back surface that is opposed to the second opposed surface, and a male stepped surface that is arranged between the first back surface and the second back surface and is opposed to the female stepped surface.

### TECHNICAL FIELD

The present disclosure relates to a connector.

### BACKGROUND

Patent Document 1 discloses a connector in which a male housing (described as a female connector housing in Patent Document 1) and a female housing (described as a male connector housing in Patent Document 1) are fitted together. The male housing has a tubular hood part. A male terminal fitting (described as electrical connection part in Patent Document 1) is arranged within the hood part so as to protrude from the back surface of the hood part. When the female housing is fitted into the hood part, a female terminal fitting included in the female housing is connected to the male terminal fitting. This type of connector is also disclosed in Patent Documents 2 to 4.

### PRIOR ART DOCUMENT

### Patent Document

Patent document 1: JP H07-161411 A
Patent document 2: JP H07-220798 A
Patent Document 3: JP 2008-166105 A
Patent Document 4: JP 2014-017085 A

### SUMMARY OF THE INVENTION

### Problems to be Solved

In this type of connector, foreign matter may intrude through the gap between the inner peripheral surface of the hood part and the outer peripheral surface of the female housing that is fitted to the hood part, and the foreign matter may make its way around to the front end surface of the female housing and contact the male terminal fitting. If the foreign matter contacts the male terminal fitting, the male terminal fitting may be short-circuited via the foreign matter.

In view of this, the present disclosure provides a technique by which to make foreign matter unlikely to reach the male terminal fitting.

### Means to Solve the Problem

A connector of the present disclosure includes: a male terminal fitting; a male housing that stores the male terminal fitting; a female terminal fitting that is connected to the male terminal fitting; and a female housing that stores the female terminal fitting, wherein the male housing has a tubular hood part to which the female housing is fitted, the female housing has an opposed surface that is opposed to a back surface of the hood part in a fitted state in which the female housing is fitted to the hood part, the opposed surface has a first opposed surface in which an insertion port for the male terminal fitting is open, and a second opposed surface that is arranged with a female stepped surface between the second opposed surface and the first opposed surface, the second opposed surface is arranged above the first opposed surface and is shifted in position from the first opposed surface in a fitting direction or a disengagement direction, where the fitting direction is defined as a direction in which the female housing is fitted to the hood part, the disengagement direction is defined as a direction in which the female housing is disengaged from the hood part, and a direction intersecting the fitting direction is defined as an up-and-down direction, and the back surface has a first back surface that is opposed to the first opposed surface, a second back surface that is opposed to the second opposed surface, and a male stepped surface that is arranged between the first back surface and the second back surface and is opposed to the female stepped surface.

### Effect of the Invention

According to the present disclosure, it is possible to make foreign matter unlikely to reach the male terminal fitting.

### BRIEF DESCRIPTION OF THE DRAWINGS

FIG. 1 is a perspective view of a connector according to a first embodiment.

FIG. 2 is a front view of a male housing that stores male terminal fittings.

FIG. 3 is a perspective view of a female housing.

FIG. 4 is a front view of the female housing.

FIG. 5 is a side cross-sectional view of the connector.

FIG. 6 is an illustrative diagram showing the flow of foreign matter.

### DETAILED DESCRIPTION TO EXECUTE THE INVENTION

### Description of Embodiments of Disclosure

First, embodiments of the present disclosure will be listed and described.

A connector of the present disclosure is as follows.

(1) A connector includes: a male terminal fitting; a male housing that stores the male terminal fitting; a female terminal fitting that is connected to the male terminal fitting; and a female housing that stores the female terminal fitting, wherein the male housing has a tubular hood part to which the female housing is fitted, the female housing has an opposed surface that is opposed to a back surface of the hood part in a fitted state in which the female housing is fitted to the hood part, the opposed surface has a first opposed surface in which an insertion port for the male terminal fitting is open, and a second opposed surface that is arranged with a female stepped surface between the second opposed surface and the first opposed surface, the second opposed surface is arranged above the first opposed surface and is shifted in position from the first opposed surface in a fitting direction or a disengagement direction, where the fitting direction is defined as a direction in which the female housing is fitted to the hood part, the disengagement direction is defined as a direction in which the female housing is disengaged from the hood part, and a direction intersecting the fitting direction is defined as an up-and-down direction, and the back surface has a first back surface that is opposed to the first opposed surface, a second back surface that is opposed to the second opposed surface, and a male stepped surface that is arranged between the first back surface and the second back surface and is opposed to the female stepped surface.

With this configuration, even if a foreign matter intrudes through the gap between the upper surface of the female housing and the top wall of the hood part and reaches the second opposed surface, the foreign matter is likely to become trapped between the female stepped surface and the male stepped surface. Accordingly, the foreign matter is unlikely to reach the first opposed surface that is arranged below the second opposed surface. As a result, the foreign matter is unlikely to reach the male terminal fitting that is inserted into the insertion port.

(2) The first opposed surface may be arranged ahead of the second opposed surface in the fitting direction, and the first back surface may be arranged ahead of the second back surface in the fitting direction.

With this configuration, even if a foreign matter reaches the second opposed surface, the foreign matter is likely to remain on the female stepped surface. Accordingly, the foreign matter is unlikely to reach the first opposed surface that is arranged below the second opposed surface. As a result, the foreign matter is unlikely to reach the male terminal fitting that is inserted into the insertion port.

(3) The female housing may have a discharge hole that is open in at least one of the female stepped surface and the second opposed surface.

With this configuration, a foreign matter that has reached the second opposed surface is easily discharged to the discharge hole before reaching the first opposed surface. Therefore, the foreign matter is further unlikely to reach the first opposed surface and to reach the male terminal fitting.

(4) A bottom of an inner peripheral surface of the discharge hole may have an inclined surface that is inclined obliquely downward in the disengagement direction.

With this configuration, the inclined surface can guide a foreign matter in the discharge hole to the side opposite to the female stepped surface.

(5) The back surface may have a third back surface that is arranged below the first back surface, and an inner peripheral surface of the hood part may have a discharge groove that extends from the third back surface.

With this configuration, even if a foreign matter reaches between the first back surface and the first opposed surface, the foreign matter is easily discharged into the discharge groove that is arranged below the first back surface. Accordingly, it is possible to prevent the foreign matter from becoming stuck between the first opposed surface and the first back surface and continuing to contact the male terminal fitting.

(6) The third back surface may be arranged ahead of the first back surface in the disengagement direction with a second male stepped surface interposed between the third back surface and the first back surface. The second male stepped surface may have a slope part that is inclined obliquely downward in the disengagement direction.

With this configuration, the slope part can guide a foreign matter that has fallen through the gap between the first opposed surface and the first back surface to the discharge groove.

(7) The male housing may have a convex portion that protrudes from the first back surface. In the fitted state, the convex portion may be arranged in the insertion port. The male terminal fitting may protrude from a tip of the convex portion.

With this configuration, the portion of the male terminal fitting that is arranged outside (in the fitting direction) the insertion port is covered by the convex portion. Accordingly, a foreign matter is likely to fall below the male terminal fitting along the outer periphery of the convex portion, and is unlikely to reach the male terminal fitting.

### DESCRIPTION OF EMBODIMENTS OF PRESENT DISCLOSURE

Specific examples of the present disclosure will be described below with reference to the drawings. It should be noted that the present invention is not limited to the examples herein, but rather is indicated by the scope of claims, and is intended to include all modifications within a meaning and scope equivalent to the scope of claims.

### First Embodiment

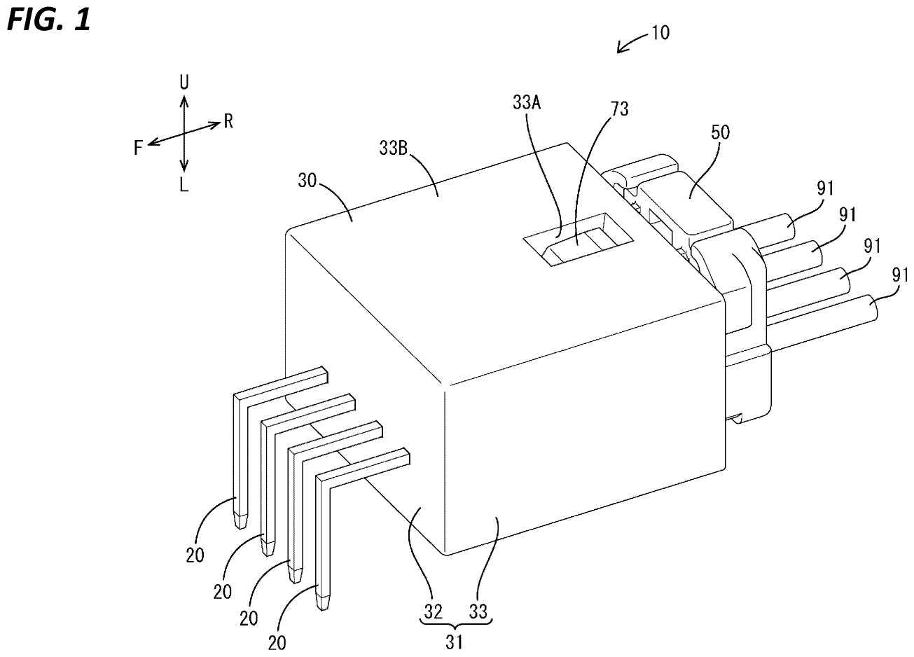

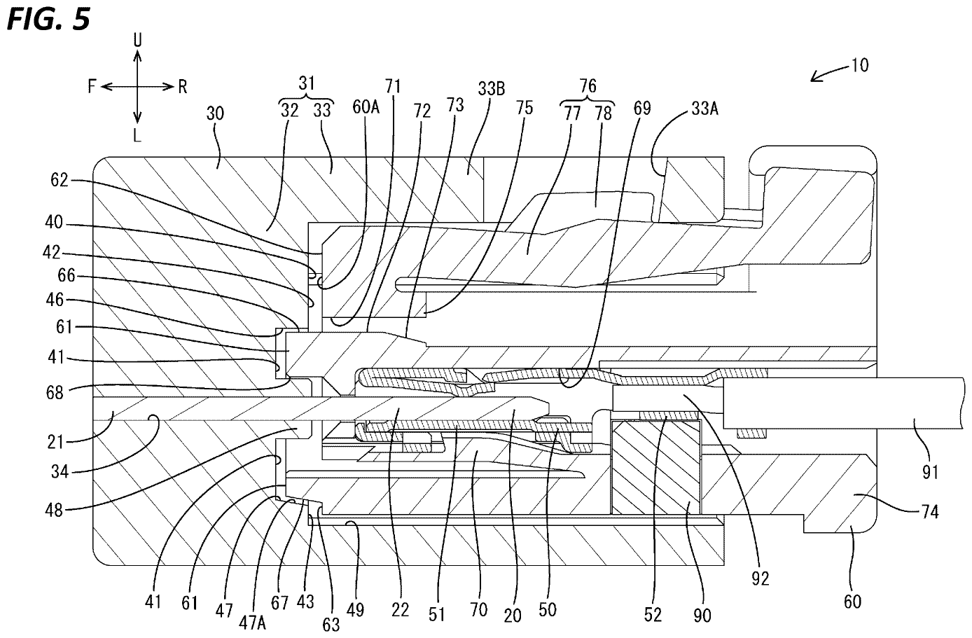

FIG. 1 discloses a connector 10 according to a first embodiment. As shown in FIG. 5, the connector 10 includes a male terminal fitting 20, a male housing 30, a female terminal fitting 50, a female housing 60, and a retainer 90.

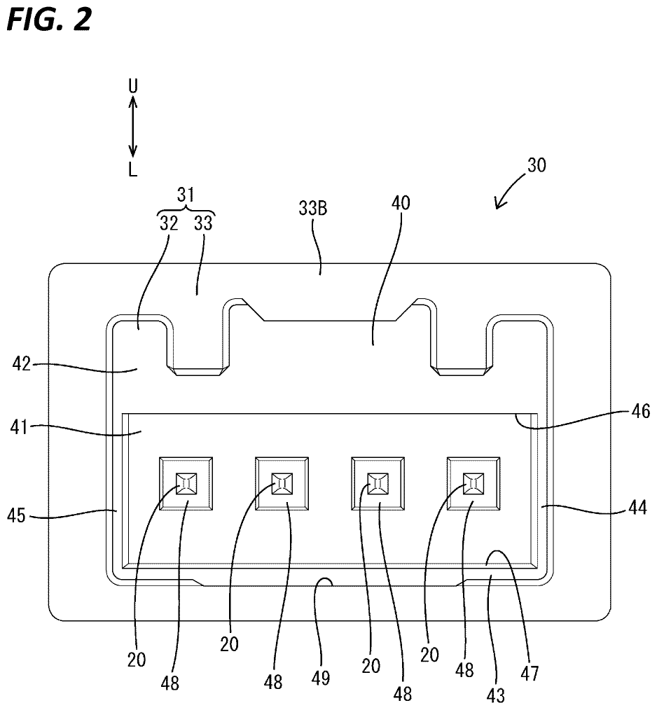

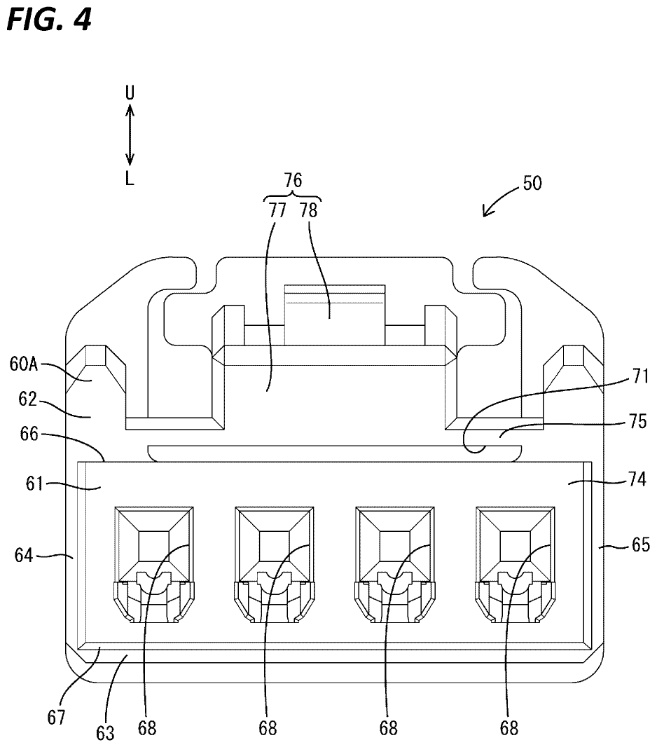

The male housing 30 and the female housing 60 are fitted together. In the following description, the fitting direction in which the female housing 60 is fitted to the male housing 30 will be referred to as the forward direction, and the disengagement direction in which the female housing 60 is disengaged from the male housing 30 will be referred to as the rearward direction. The up-and-down direction shown in FIGS. 2, 4, 5, and 6 will be referred to as the up-and-down direction as it is. The right-and-left direction shown in FIGS. 2 and 4 will be referred to as the width direction. In the drawings, the front side is indicated as “F”, the rear side is indicated as “R”, the upper side is indicated as “U”, and the lower side is indicated as “L”.

### <Male Terminal Fitting>

The male terminal fitting 20 is electrically conductive. The male terminal fitting 20 is made of metal, for example. As shown in FIG. 5, the male terminal fitting 20 have a base 21 and a tab 22. The tab 22 is arranged behind the base 21 and protrudes rearward. That is, the base 21 and the tab 22 extend in the front-and-rear direction. A plurality of male terminal fittings 20 (four in the present embodiment) are provided at intervals in the width direction.

### <Male Housing>

The male housing 30 stores the plurality of male terminal fitting 20. The male housing 30 has insulating properties. The male housing 30 is made of a synthetic resin, for example. The male housing 30 has a hood part 31 as shown in FIGS. 2 and 5. The hood part 31 has a shape of a tube, more specifically, an angular tube that is open rearward. The hood part 31 has a wall portion 32 and a tubular portion 33 that protrudes from the outer periphery of the wall portion 32 rearward in the shape of a cylinder (more specifically, the shape of an angular cylinder).

The wall portion 32 is thick in the front-and-rear direction. The thickness of the wall portion 32 is set as desired. The wall portion 32 has a through hole 34 that stores the base 21 of the male terminal fitting 20. The through hole 34 penetrates the wall portion 32 in the front-and-rear direction. The male terminal fitting 20 may be held in the through hole 34 by insert molding, for example. The tab 22 of the male terminal fitting 20 protrudes rearward from the rear surface of the wall portion 32 and is arranged in protruding into the hood part 31. A plurality (four in the present embodiment) of through holes 34 are provided at intervals in the width direction. The male terminal fittings 20 are inserted into the plurality of through holes 34.

A back surface 40 of the hood part 31 is formed on the rear surface of the wall portion 32. As shown in FIG. 2, the back surface 40 extends in the up-and-down direction and the width direction and is oriented rearward. The back surface 40 has a first back surface 41, a second back surface 42, a third back surface 43, a fourth back surface 44, and a fifth back surface 45. The first back surface 41, the second back surface 42, the third back surface 43, the fourth back surface 44, and the fifth back surface 45 are flat surfaces and are oriented rearward. The second back surface 42, the third back surface 43, the fourth back surface 44, and the fifth back surface 45 are continuous surfaces without steps.

The second back surface 42 is arranged above the first back surface 41 with a male stepped surface 46 interposed therebetween. The second back surface 42 is arranged behind the first back surface 41. The lower end of the second back surface 42 is continuous with the rear end of the male stepped surface 46, and the upper end of the first back surface 41 is continuous with the front end of the male stepped surface 46. The male stepped surface 46 extends in the front-and-rear direction and width direction and is oriented downward.

The third back surface 43 is arranged below the first back surface 41 with a second male stepped surface 47 interposed therebetween. The third back surface 43 is arranged behind the first back surface 41. The upper end of the third back surface 43 is continuous with the rear end of the second male stepped surface 47, and the lower end of the first back surface 41 is continuous with the front end of the second male stepped surface 47. The second male stepped surface 47 extends in the front-and-rear direction and the width direction and is oriented upward. The second male stepped surface 47 has a slope part 47A that is inclined obliquely downward in the rearward direction (see FIG. 5).

The fourth back surface 44 is arranged on one side in the width direction of the first back surface 41, and the fifth back surface 45 is arranged on the other side in the width direction of the first back surface 41. The fourth back surface 44 is flush with the second back surface 42 and is also flush with the third back surface 43. The fifth back surface 45 is flush with the second back surface 42 and is also flush with the third back surface 43.

The wall portion 32 has convex portions 48 that protrude rearward beyond the first back surface 41. The plurality (four in the present embodiment) of convex portions 48 are provided at intervals in the width direction, in correspondence with the through holes 34. The through holes 34 penetrate the wall portion 32 in the front-and-rear direction so as to pass through the convex portions 48. The tabs 22 of the male terminal fittings 20 protrude rearward from openings at the tips of the convex portions 48. The convex portions 48 are inserted into insertion ports 68 of the female housing 60 in the fitted state in which the female housing 60 is fitted to the hood part 31 of the male housing 30.

The tubular portion 33 has a tubular shape as described above. The bottom of the inner peripheral surface of the tubular portion 33 (that is, the inner peripheral surface of the hood part 31) has a discharge groove 49. The discharge groove 49 extends rearward from the third back surface 43. The discharge groove 49 extends up to the rear end of the hood part 31. As shown in FIG. 1, the tubular portion 33 has a locking hole 33A that locks the female housing 60. The locking hole 33A penetrates the top wall 33B of the tubular portion 33 in the up-and-down direction.

### <Female Terminal Fitting>

The female terminal fitting 50 are electrically conductive. The female terminal fitting 50 is made of metal, for example. The female terminal fitting 50 is formed by bending a metal plate, for example. As shown in FIG. 5, the female terminal fitting 50 has a main body part 51 and an electric wire connection portion 52. The main body part 51 has a tubular shape, and the tab 22 is inserted therein. Accordingly, the female terminal fitting 50 is electrically connected to the male terminal fitting 20. A conductor 92 of an electric wire 91 is electrically connected to the electric wire connection portion 52 by crimping or the like. A plurality (four in the present embodiment) of female terminal fittings 50 are provided at intervals in the width direction.

### <Female Housing>

The female housing 60 stores the plurality of female terminal fittings 50. The female housing 60 has insulating properties. The female housing 60 is made of a synthetic resin, for example. As shown in FIG. 5, the female housing 60 has an opposed surface 60A that is opposed to the back surface 40 of the hood part 31 in the fitted state in which the female housing 60 is fitted to the hood part 31 of the male housing 30. The opposed surface 60A is formed in front of the female housing 60. As shown in FIG. 4, the opposed surface 60A has a first opposed surface 61, a second opposed surface 62, a third opposed surface 63, a fourth opposed surface 64, and a fifth opposed surface 65. The first opposed surface 61, the second opposed surface 62, the third opposed surface 63, the fourth opposed surface 64, and the fifth opposed surface 65 are flat surfaces that are oriented forward. The second opposed surface 62, the third opposed surface 63, the fourth opposed surface 64, and the fifth opposed surface 65 are continuous surfaces without any steps.

In the fitted state, the first opposed surface 61 is opposed to the first back surface 41. The second opposed surface 62 is opposed to the second back surface 42. The third opposed surface 63 is opposed to the third back surface 43. The fourth opposed surface 64 is opposed to the fourth back surface 44. The fifth opposed surface 65 is opposed to the fifth back surface 45.

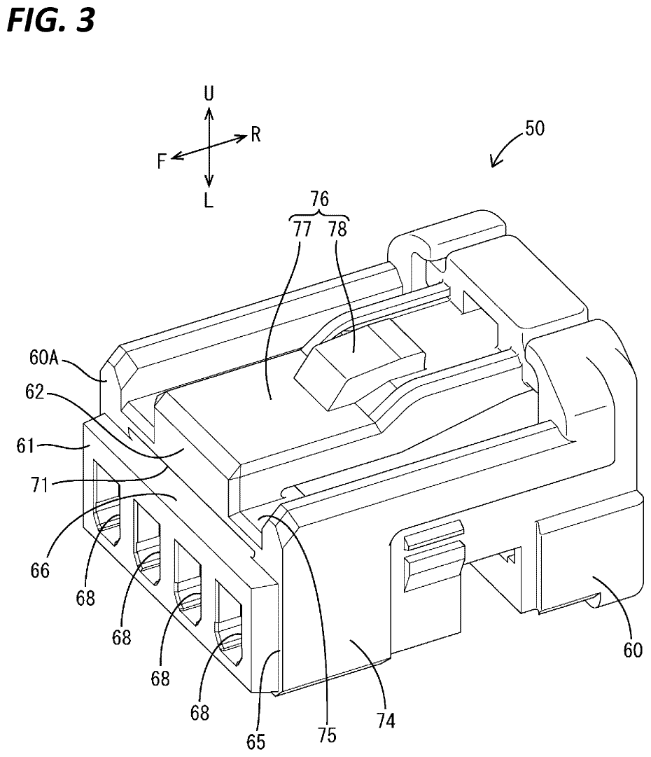

As shown in FIGS. 3 to 5, the second opposed surface 62 is arranged above the first opposed surface 61 with a female stepped surface 66 interposed therebetween. The second opposed surface 62 is arranged behind the first opposed surface 61. The lower end of the second opposed surface 62 is continuous with the rear end of the female stepped surface 66, and the upper end of the first opposed surface 61 is continuous with the front end of the female stepped surface 66. The female stepped surface 66 extends in the front-and-rear direction and the width direction and is oriented upward. The female stepped surface 66 is opposed to the male stepped surface 46 in the fitted state.

As shown in FIGS. 4 and 5, the third opposed surface 63 is arranged below the first opposed surface 61 with the second female stepped surface 67 interposed therebetween. The third opposed surface 63 is arranged behind the first opposed surface 61. The upper end of the third opposed surface 63 is continuous with the rear end of the second female stepped surface 67, and the lower end of the first opposed surface 61 is continuous with the front end of the second female stepped surface 67. The second female stepped surface 67 is inclined downward in the backward direction and is oriented downward. The second female stepped surface 67 is opposed to the second male stepped surface 47 in the fitted state.

As shown in FIG. 4, the fourth opposed surface 64 is arranged on one side in the width direction of the first opposed surface 61, and the fifth opposed surface 65 is arranged on the other side in the width direction of the first opposed surface 61. The fourth opposed surface 64 is flush with the second opposed surface 62 and is also flush with the third opposed surface 63. The fifth opposed surface 65 is flush with the second opposed surface 62 and is also flush with the third opposed surface 63.

As shown in FIG. 5, the female housing 60 has the insertion ports 68 that are open in the first opposed surface 61, cavities 69 that communicate with the insertion ports 68, and lances 70. The male terminal fittings 20 are inserted into the insertion ports 68. The plurality (four in the present embodiment) of insertion ports 68 are provided at intervals in the width direction (see FIGS. 3 and 4). The front ends of the cavities 69 communicate with the insertion ports 68. The cavities 69 are provided in correspondence with the insertion ports 68. The female terminal fittings 50 are arranged in the cavities 69. The lances 70 protrude into the cavities 69 from below. The lances 70 lock the female terminal fittings 50 arranged in the cavities 69 from the rear side.

As shown in FIGS. 3 to 5, the female housing 60 has a discharge hole 71. The discharge hole 71 is formed in the second opposed surface 62. The discharge hole 71 can also be said to be formed between the second opposed surface 62 and the female stepped surface 66. The discharge hole 71 has a shape that is long in the width direction. The discharge hole 71 is arranged across the plurality of insertion ports 68 in the width direction. As shown in FIG. 5, the bottom of the inner peripheral surface of the discharge hole 71 has a flat horizontal surface 72 and an inclined surface 73 that is inclined downward in the rearward direction. The front end of the horizontal surface 72 is continuous with the rear end of the female stepped surface 66 and is flush with the female stepped surface 66. The front end of the inclined surface 73 is continuous with the rear end of the horizontal surface 72.

As shown in FIGS. 3 to 5, the female housing 60 has a housing main body 74, a bridge part 75, and a lock arm 76. The housing main body 74 has the cavities 69 described above. The bridge part 75 rises from both sides in the width direction of the upper surface of the housing main body 74 at the front end side of the housing main body 74, and has a shape in which the upper ends are connected to each other. The area surrounded by the housing main body 74 and the bridge part 75 constitutes the discharge hole 71. The lock arm 76 has an arm part 77 that extends in a cantilever shape rearward from the upper surface of the bridge part 75, and a lock part 78 that is formed on the upper surface of the arm part 77. During the process of fitting the female housing 60 to the male housing 30, the lock arm 76 enters the hood part 31 while being pressed and bent downward by the open end of the hood part 31, and the lock part 78 enters the locking hole 33A of the hood part 31, so that the lock arm 76 is locked to the hood part 31. This maintains the fitted state.

### <Retainer>

The retainer 90 is locked to the female housing 60 to prevent the female terminal fittings 50 arranged in the cavities 69 from slipping out rearward.

### <Operation of Connector>

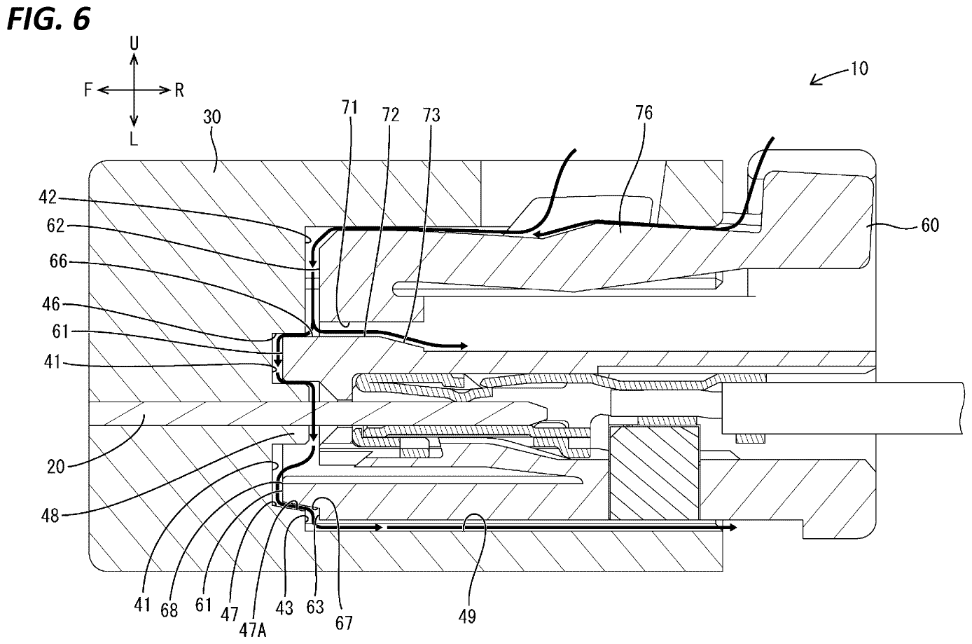

In the fitted state, the connector 10 may have a risk of foreign matter intruding the gap between the male housing 30 and the female housing 60. For example, when the connector 10 is placed in an oil environment, oil may be scattered on the upper surface of the lock arm 76 together with foreign matter such as scrap metal from the motor. The foreign matter may be carried by the oil and move along the upper surface of the lock arm 76 as shown by the arrows in FIG. 6, and may intrude the gap between the male housing 30 and the female housing 60. In the event of intrusion of the foreign matter, a certain male terminal fitting 20 may be short-circuited through the foreign matter with another male terminal fitting 20 that is arranged at an interval in the width direction. Therefore, it is necessary to make the foreign matter unlikely to contact the male terminal fittings 20.

To address this issue, in the connector 10, the second opposed surface 62 is arranged above the first opposed surface 61 where the insertion port 68 is open, with a female stepped surface 66 interposed therebetween. The second opposed surface 62 is arranged behind the first opposed surface 61. The female stepped surface 66 is oriented upward. Therefore, even if a foreign matter moves forward on the upper surface of the lock arm 76 and reaches the second opposed surface 62, the foreign matter tends to remain on the female stepped surface 66 and is unlikely to reach the first opposed surface 61. This makes the foreign matter unlikely to contact the male terminal fitting 20.

Furthermore, the second opposed surface 62 has the discharge hole 71 that is open. Therefore, a foreign matter having reached the second opposed surface 62 is easily discharged to the discharge hole 71. Therefore, with this configuration, foreign matter is more unlikely to reach the first opposed surface 61, and the contact between the foreign matter and the male terminal fitting 20 can be more reliably prevented.

The bottom of the inner peripheral surface of the discharge hole 71 has an inclined surface 73 that is inclined obliquely downward in the rearward direction. Therefore, with this configuration, the foreign matter in the discharge hole 71 can be guided rearward by the inclined surface 73.

The third back surface 43 is arranged below the first back surface 41. The bottom of the inner peripheral surface of the hood part 31 has the discharge groove 49 extending rearward from the third back surface 43. With this configuration, a foreign matter is easily discharged to the discharge groove 49 arranged below the first back surface 41. This prevents the foreign matter from becoming stuck between the first opposed surface 61 and the first back surface 41 and continuing to contact the male terminal fitting 20.

The third back surface 43 is arranged behind the first back surface 41, with the second male stepped surface 47 interposed between the third back surface 43 and the first back surface 41. The second male stepped surface 47 has the slope part 47A that is inclined obliquely downward in the rearward direction. With this configuration, a foreign matter that has fallen through the gap between the first opposed surface 61 and the first back surface 41 can be guided to the discharge groove 49 by the slope part 47A.

The male housing 30 has the convex portions 48 protruding from the back surface 40. In the fitted state, each convex portion 48 is arranged in a state of being inserted into the insertion port 68. The male terminal fitting 20 protrude rearward from the opening formed at the tip of the convex portion 48. With this configuration, the portion of the male terminal fitting 20 that is arranged outside (in front of) the insertion port 68 is covered by the convex portion 48. Accordingly, a foreign matter is likely to fall below the male terminal fitting 20 along the outer periphery of the convex portion 48, and is unlikely to reach the male terminal fitting 20.

### Other Embodiments of Present Disclosure

The embodiments disclosed herein should be considered as illustrative and should not be restrictive in all respects.

(1) The second opposed surface may be arranged in front of the first opposed surface. The second back surface may be arranged in front of the first back surface. The female stepped surface may be oriented downward. The male stepped surface may be oriented upward.

(2) The third back surface may be flush with the first back surface.

(3) The discharge hole may be opened through the female stepped surface. The discharge hole may be opened through both the second opposed surface and the female stepped surface.

(4) The inner peripheral surface of the discharge hole may not have an inclined surface.

(5) The inner peripheral surface of the hood part may not have a discharge groove.

(6) The second male stepped surface may not have a slope part.

(7) The male housing may not have a convex portion.

### LIST OF REFERENCE NUMERALS

10 Connector
20 Male terminal fitting
21 Base
22 Tab
30 Male housing
31 Hood part
32 Wall portion
33 Tubular portion
33A Locking hole
33B Top wall
34 Through hole
40 Back surface
41 First back surface
42 Second back surface
43 Third back surface
44 Fourth back surface
45 Fifth back surface
46 Male stepped surface
47 Second male stepped surface
47A Slope part
48 Convex portion
49 Discharge groove
50 Female terminal fitting
51 Main body part
52 Electric wire connection portion
60 Female housing
60A Opposed surface
61 First opposed surface
62 Second opposed surface
63 Third opposed surface
64 Fourth opposed surface
65 Fifth opposed surface
66 Female stepped surface
67 Second female stepped surface
68 Insertion port
69 Cavity
70 Lance
71 Discharge hole
72 Horizontal surface
73 Inclined surface
74 Housing main body
75 Bridge part
76 Lock arm
77 Arm part
78 Lock part
90 Retainer
91 Electric wire
92 Conductor

1. A connector comprising:
a male terminal fitting;
a male housing that stores the male terminal fitting;
a female terminal fitting that is connected to the male terminal fitting; and
a female housing that stores the female terminal fitting,
wherein the male housing has a tubular hood part to which the female housing is fitted,
the female housing has an opposed surface that is opposed to a back surface of the hood part in a fitted state in which the female housing is fitted to the hood part,
the opposed surface has a first opposed surface in which an insertion port for the male terminal fitting is open, and a second opposed surface that is arranged with a female stepped surface between the second opposed surface and the first opposed surface,
the second opposed surface is arranged above the first opposed surface and is shifted in position from the first opposed surface in a fitting direction or a disengagement direction, where the fitting direction is defined as a direction in which the female housing is fitted to the hood part, the disengagement direction is defined as a direction in which the female housing is disengaged from the hood part, and a direction intersecting the fitting direction is defined as an up-and-down direction, and
the back surface has a first back surface that is opposed to the first opposed surface, a second back surface that is opposed to the second opposed surface, and a male stepped surface that is arranged between the first back surface and the second back surface and is opposed to the female stepped surface.

2. The connector according to claim 1, wherein the first opposed surface is arranged ahead of the second opposed surface in the fitting direction, and the first back surface is arranged ahead of the second back surface in the fitting direction.

3. The connector according to claim 2, wherein the female housing has a discharge hole that is open in at least one of the female stepped surface and the second opposed surface.

4. The connector according to claim 3, wherein a bottom of an inner peripheral surface of the discharge hole has an inclined surface that is inclined obliquely downward in the disengagement direction.

5. The connector according to claim 1,
wherein the back surface has a third back surface that is arranged below the first back surface, and
an inner peripheral surface of the hood part has a discharge groove that extends from the third back surface.

6. The connector according to claim 5,
wherein the third back surface is arranged ahead of the first back surface in the disengagement direction with a second male stepped surface interposed between the third back surface and the first back surface, and
the second male stepped surface has a slope part that is inclined obliquely downward in the disengagement direction.

7. The connector according to claim 6,
wherein the male housing has a convex portion that protrudes from the first back surface,
the convex portion is arranged in the insertion port in the fitted state, and
the male terminal fitting protrudes from a tip of the convex portion.

8. The connector according to claim 1,
wherein the male housing has a convex portion that protrudes from the first back surface,
the convex portion is arranged in the insertion port in the fitted state, and
the male terminal fitting protrudes from a tip of the convex portion.
